(19) United States
(12) Patent Application Publication
(10) Pub. No.: US 2008/0201770 A1
(43) Pub. Date: Aug. 21, 2008

(54) COMMUNICATION CONTROL DEVICE

(75) Inventors: Yuuki OKAMOTO, Osaka (JP); Kentaro Saito, Osaka (JP); Nobuhiko Arashin, Osaka (JP)

Correspondence Address: DICKINSON WRIGHT PLLC, 1901 L STREET NW, SUITE 800, WASHINGTON, DC, 20036, US

(73) Assignee: MATSUSHITA ELECTRIC INDUSTRIAL CO., LTD., Osaka (JP)

(21) Appl. No.: 12/033,865

(22) Filed: Feb. 19, 2008

(30) Foreign Application Priority Data
Feb. 21, 2007 (JP) 2007-040423

(51) Int. Cl. H04L 9/32; G06F 15/16; G06F 21/00

(52) U.S. Cl. 726/7; 709/217

(57) ABSTRACT

A communication control device with high confidentiality is provided, which allows content access only from devices in a specific group, and ensures that no content information is exposed to any devices for which content access is not allowed. A password selection portion selects a common password required for connecting to a network, or a secret password required for establishing a communication channel with a specific reception device. A transmission portion transmits contents or information associated therewith to the reception device via the network established by using the common password or the secret password.

### FIELD OF THE INVENTION

The present invention relates to a communication control device which has the function of access control during content transmission/reception via a network.

### BACKGROUND OF THE INVENTION

In recent years, content exchange via a network has been actively conducted. Once an in-home LAN is constructed, it is possible to, for example, play back, copy, or move streaming AV contents saved in a personal computer (hereinafter, a “PC”) or a set-top box with a built-in hard disk (hereinafter, an “STB”) from a television in another room or a cell phone.

Generally, some contents stored in devices are publicly exposed via the network, and some are not. Specifically, the number of contents that can be publicly opened by devices connected to the network are generally limited for security and privacy reasons. When a content source is a PC, such limitation is implemented by, for example, setting a flag per content item, or per folder containing a content item, regarding whether public exposure is allowed. Any receiver device, which is a content requester, is limited in accessing any contents that are not allowed to be publicly exposed to the outside, such that the contents are not indicated in a content list or cannot be played back even if such an attempt is made.

In addition, there are some methods for preventing unrestricted content leakage, in which the devices that can access contents or a content source are limited. In general, any device for which transmission is allowed is registered in advance with a sender device, i.e., the content source. The device registration is performed by a user operation or suchlike. The sender device transmits contents only when the registered device requests content acquisition. Whether the content requester is the registered device can be determined by checking a unique value, such as an Ethernet MAC address, which is uniquely assigned to each device.

Furthermore, some methods have been proposed, in which device-specific IDs are used to impose stepwise access limitation per content item (e.g., Japanese Laid-Open Patent Publication No. 2001-297063). Such methods are intended to confirm the access right of the receiver device based on the ID of the receiver device (the content requester), which is received by the sender device (the content source), and also to notify the receiver device about the storage locations of any accessible contents. The storage locations (e.g., URLs) of any contents that are not allowed to be accessed are not notified, and therefore the receiver device cannot access the contents. As such, the stepwise access limitation can be set both per content item and per device.

In the case of the above-described methods, however, there is a possibility that content-related information might be eavesdropped upon. Even in the case of contents for which access by a device is prohibited, if another device accesses the contents, information related to the contents can be transmitted in a packet over the network. In this case, the information related to the contents can be obtained by monitoring the network. Content data in binary format is often transmitted after being encrypted, but in general, content information, such as a title, is simply transmitted without being encrypted. Therefore, for example, when the content owner does not wish the content title information to be seen, it is necessary to employ an access control method with high confidentiality that prevents any leakage of information related to saved contents.

Conceivably, such access control with high confidentiality is required by, for example, a cable television (hereinafter, “CATV”) system as described below. In the case of the CATV system, if any contents saved in an STB for CATV can be viewed on a PC or a TV via a network, the user can enjoy the benefit of being capable of viewing the contents on various terminal devices.

In some cases, however, the CATV service provider wishes to intentionally effect access limitation in order to prevent unrestricted content leakage to the outside. The simplest method for that purpose is not to expose any contents to the outside, but this method does not allow any devices to be used for viewing via the network, resulting in significantly-reduced convenience, which might lead to no increase or even reduction in the number of subscribers (the number of STBs under contract).

To prevent such a situation, it has to be ensured that only the STBs under the same contract can have content access. As a result, the CATV service provider can enhance user convenience, thereby increasing the number of STBs under contract. Therefore, there is some demand for a flexible access control scheme in which contents are widely open to devices in a specific group (under the same contract), whereas access limitation is imposed on other devices, such that they cannot acquire any content-related information.

In an example of the generally-known communication schemes with enhanced confidentiality, communication channels are encrypted. In the case of, for example, a wireless LAN, a common WEP (wired equivalent privacy) key is set between terminal devices that communicate with each other, and encrypted communication is performed based on the WEP key. In this case, any terminal device without the WEP key cannot decrypt the details of communication, and therefore the confidentiality of the communication between the terminal devices with the WEP key is ensured.

In another example of the generally-known communication schemes with enhanced confidentiality, a common password is set between terminal devices that are connected by a packet communication link established via a coaxial cable network. In this exemplary scheme, the link can be established between any terminal devices if they have the same password, but no link can be established between any terminal devices with different passwords. As such, by using a scheme in which a password is set per communication channel, it becomes possible to perform communication with high confidentiality.

The above-described scheme in which the password is set for the communication channel can be used for access limitation. Specifically, the scheme allows any terminal devices with a specific password to establish a link therebetween, thereby making it possible for a receiver terminal device, which is a content requester, to access contents. However, no link can be established by any terminal device to which the password is unknown, and therefore the device fails to access the contents.

However, this access limitation scheme is disadvantageous in that the user cannot access any contents saved in a terminal device with a password different from that held by his/her own terminal device. For example, in the environment where a plurality of STBs and a PC are connected together via a network using coaxial cables, it is possible to view, through one STB, any contents saved in another STB with the same password, but not possible to view any contents saved in the PC with a different password. In this case, the user cannot access any contents the user was originally allowed to access (without any access limitation), and therefore user convenience is greatly impaired.

### BRIEF SUMMARY OF THE INVENTION

Therefore, an object of the present invention is to provide a communication control device with high confidentiality that allows content access only from devices in a specific group, considering user convenience, while ensuring that no content information is exposed to any devices for which content access is not allowed.

To achieve the above object, the present invention provides a communication control device for use in a network constituted by a first terminal device holding content, and a plurality of second terminal devices connected to the first terminal device, the control device comprising:

a transmission unit for transmitting either the content or information associated therewith, or both, to the second terminal devices;

a password selection unit for selecting and reading either a common password required for connecting to the network or a secret password required for establishing a communication channel with a specific one of the second terminal devices; and

a transmission control unit for causing the transmission unit to transmit either the content or the associated information, or both, via the network established by using the password selected by the password selection unit.

The present invention provides another communication control device for use in a network constituted by a first terminal device holding content, and a plurality of second terminal devices connected to the first terminal device, the control device comprising:

a reception unit for receiving either the content or information associated therewith, or both, from the first terminal device;

a password selection unit for selecting and reading either a common password required for connecting to the network or a secret password required for establishing a communication channel with the first terminal device; and

a reception control unit for causing the reception unit to receive either the content or the associated information, or both, via the network established by using the password selected by the password selection unit.

The present invention provides still another communication control device for use in a network constituted by a first terminal device holding content, and a plurality of second terminal devices connected to the first terminal device, the control device comprising:

a transmission unit for transmitting either the content or information associated therewith, or both, to a specific one of the second terminal devices;

a frequency value holding unit for holding a plurality of frequency values for use in signal transmission;

a frequency value selection unit for selecting and reading one of the frequency values held in the frequency value holding unit; and

a transmission control unit for causing the transmission unit to transmit either the content or the associated information, or both, via the network established by using the frequency value selected by the frequency value selection unit.

The present invention provides still another communication control device for use in a network constituted by a first terminal device holding content, and a plurality of second terminal devices connected to the first terminal device, the control device comprising:

a reception unit for receiving either the content or information associated therewith, or both, from the first terminal device;

a frequency value holding unit for holding a plurality of frequency values for use in signal transmission;

a frequency value selection unit for selecting and reading one of the frequency values held in the frequency value holding unit; and

a reception control unit for causing the reception unit to receive either the content or the associated information, or both, via the network established by using the frequency value selected by the frequency value selection unit.

The present invention enables content transmission/reception via a network with high confidentiality in such a manner as to render contents widely open to devices that belong to a specific group, while ensuring that no content information is disclosed to any devices that do not belong to that group.

While the novel features of the invention are set forth particularly in the appended claims, the invention, both as to organization and content, will be better understood and appreciated, along with other objects and features thereof, from the following detailed description taken in conjunction with the drawings.

### BRIEF DESCRIPTION OF THE SEVERAL VIEWS OF THE DRAWING

FIG. 1 is a block diagram illustrating the configuration of a network system according to a first embodiment of the present invention.

FIG. 2 is a block diagram illustrating the configuration of a primary contractual terminal device in FIG. 1.

FIG. 3 is a block diagram illustrating the configuration of a secondary contractual terminal device in FIG. 1

FIG. 4 is a sequence diagram illustrating the procedure for content acquisition by the secondary contractual terminal device in the network system in FIG. 1.

FIG. 5 is a flowchart illustrating a content acquisition operation of the primary contractual terminal device in the network system in FIG. 1.

FIG. 6 is a flowchart illustrating a content acquisition operation of the secondary contractual terminal device in the network system in FIG. 1.

FIG. 7 is a block diagram illustrating the configuration of a network system according to a second embodiment of the present invention.

FIG. 8 is a block diagram illustrating the configuration of a primary contractual terminal device in FIG. 7.

FIG. 9 is a block diagram illustrating the configuration of a secondary contractual terminal device in FIG. 7.

FIG. 10 is a sequence diagram illustrating the procedure for content acquisition by the secondary contractual terminal device in the network system in FIG. 7.

### DETAILED DESCRIPTION OF THE INVENTION

### First Embodiment

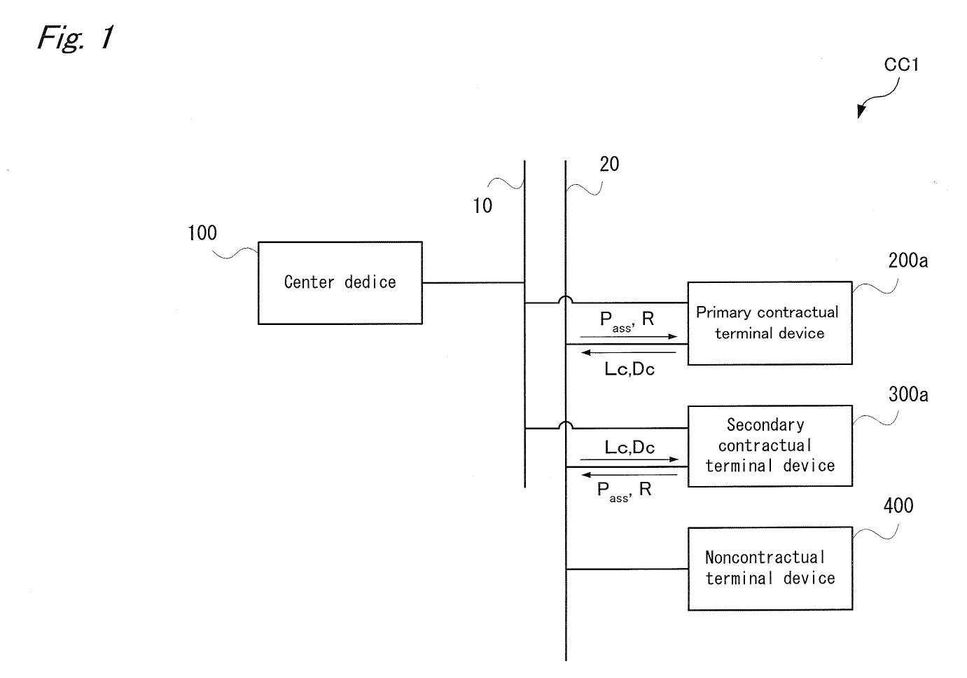

Hereinafter, a broadcast reception system according to a first embodiment of the present invention will be described with reference to FIGS. 1, 2, 3, 4, 5, and 6. Note that the present invention is directed to a communication device for use in a network system, which is intended for content transmission/reception over a network. Therefore, in the present specification, the network system will be described below by taking as an example the case where the content transmission/reception is performed by a plurality of terminal devices.

As shown in FIG. 1, a network system CC1 according to the present embodiment is generally divided into a television broadcast system and a coaxial cable network system. The television broadcast system is a system intended for television broadcasting, which is configured by connecting together a center device 100, a primary contractual terminal device 200a and a secondary contractual terminal device 300a via a broadcast link 10 using coaxial cables. The coaxial cable network system constitutes an in-home packet communication LAN configured by a communication link 20 using coaxial cables. In the coaxial cable network system, the primary contractual terminal device 200a, the secondary contractual terminal device 300a, and a noncontractual terminal device 400 are connected together by the communication link 20. The primary contractual terminal device 200a, the secondary contractual terminal device 300a, and the noncontractual terminal device 400 are collectively referred to as the “terminal devices”.

The center device 100 is a server or suchlike for distributing video contents, which is provided in a base station for television broadcasting. Each terminal device receives contents transmitted from the center device 100 via the broadcast link 10, and provides users with services for viewing and recording the received contents.

For example, the primary contractual terminal device 200a and the secondary contractual terminal device 300a are each an STB or television set with the function of receiving and demodulating broadcast from the base station. To view a program on the primary contractual terminal device 200a and the secondary contractual terminal device 300a, for example, the users of these terminal devices are supposed to make a viewing contract with a broadcast service provider, so that the service provider allows their viewing. In the present example, it is assumed that a user has made a contract to use a plurality of terminal devices; of these devices, a main terminal device is referred to as the “primary contractual terminal device 200a”, and any other device is referred to as the “secondary contractual terminal device 300a”. In addition, any terminal device under no contract with the service provider is referred to as the “noncontractual terminal device 400”.

The primary contractual terminal device 200a and the secondary contractual terminal device 300a both have the function of performing packet communication via the coaxial cable network (the communication link 20). The primary contractual terminal device 200a is capable of transmitting contents, which have been previously stored by, for example, recording programs, via the communication link 20. The secondary contractual terminal device 300a is capable of receiving contents via the communication link 20. Moreover, the secondary contractual terminal device 300a is capable of recording, playing back, and displaying the received contents. Note that in the present example, for simplification of explanation, the primary contractual terminal device 200a and the secondary contractual terminal device 300a are described as having different functions, but they may be equivalent in terms of their performance or functions. Note that the noncontractual terminal device 400 may be basically equivalent to the primary contractual terminal device 200a and the secondary contractual terminal device 300a in terms of its performance or function, except that it has not made a contract with the service provider.

For example, the noncontractual terminal device 400 is a personal computer or STB with the function of performing packet communication via the coaxial cable network (the communication link 20). The noncontractual terminal device 400 is capable of transmitting stored contents via the communication link 20, and also capable of playing back/displaying and recording contents received via the communication link 20.

It is assumed that the CATV service provider expects any contents distributed from the center device 100 to be viewed only on terminal devices under official contract. Specifically, in the case of the transmission/reception system CC1, it is required that any contents stored in the primary contractual terminal device 200a can be viewed only on the secondary contractual terminal device 300a, and cannot be viewed on the noncontractual terminal device 400. Moreover, it is required that any contents stored in the noncontractual terminal device 400 can conversely be viewed on the secondary contractual terminal device 300a and the primary contractual terminal device 200a.

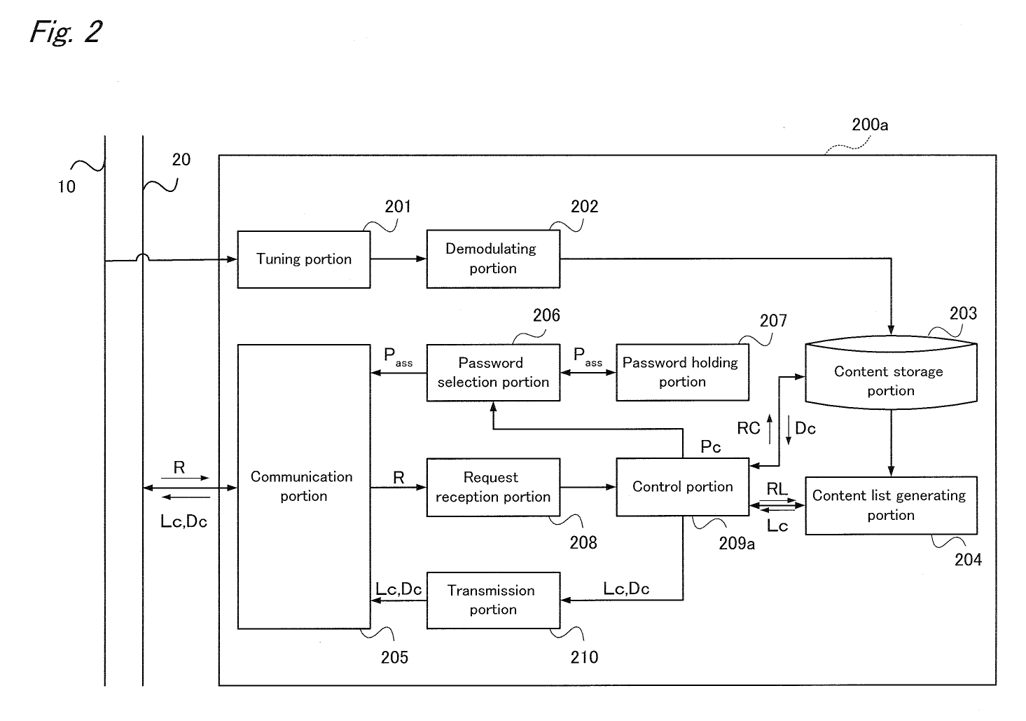

The primary contractual terminal device 200a will be described below with reference to FIG. 2. The primary contractual terminal device 200a includes a tuning portion 201, a demodulating portion 202, a content storage portion 203, a content list generating portion 204, a communication portion 205, a password selection portion 206, a password holding portion 207, a request reception portion 208, a control portion 209a, and a transmission portion 210.

The operation of the primary contractual terminal device 200a will be described below, regarding the case where the user uses the primary contractual terminal device 200a to record a broadcast program. In response to a recording instruction from the user, the primary contractual terminal device 200a receives contents broadcast from the center device 100 at the tuning portion 201 via the broadcast link 10. The received contents are demodulated by the demodulating portion 202 before being stored to the content storage portion 203. In the case of stored contents selected by the user through VOD (video on demand) or suchlike, the contents distributed via the broadcast network 20 are also received and demodulated before being stored to the content storage portion 203. The content storage portion 203 records the contents to a medium, such as a hard disk drive (hereinafter, an “HDD”) or a DVD.

The primary contractual terminal device 200a has the function of transmitting the contents stored in the content storage portion 203 over the network (the communication link 20). The primary contractual terminal device 200a is connected to the communication link 20 via the communication portion 205, which has such functions as signal modulation/demodulation, and packet transmission/reception. The request reception portion 208 receives a request R from the receiver terminal device (in the present example, the secondary contractual terminal device 300a).

When the received request R is a request to acquire a content list (hereinafter, a “content list request RL”), the content list generation portion 204 generates a list (hereinafter, a “content list Lc”) concerning information associated with contents, such as content titles and recording times. The generated content list Lc is returned to the requester terminal device (in the present example, the secondary contractual terminal device 300a) via the transmission portion 210 and the communication portion 205.

When the received request R is a request to acquire content itself (hereinafter, a “content request RC”), content data (hereinafter, “content data Dc”) is read from the content storage portion 203. The content data Dc being read is returned to the requester terminal device (in the present example, the secondary contractual terminal device 300a) via the transmission portion 210 and the communication portion 205. The transmission of the content list Lc and the content data Dc is carried out by the control portion 209a.

Note that the primary contractual terminal device 200a may not only transmit stored contents but also transmit contents being received from the broadcast link 10 in real time. In such a case, the content storage portion 203 is preferably configured by, for example, a memory device that temporarily memorizes data.

The password selection portion 206 and the password holding portion 207 hold their respective different passwords Pₐₛₛ. The passwords held by the password selection portion 206 and the password holding portion 207 will be described later. In accordance with a password change instruction signal Pc inputted from the control portion 209a, the password selection portion 206 reads and holds the password Pₐₛₛ held in the password holding portion 207, and in exchange transfers its own password Pₐₛₛ to the password holding portion 207. The password Pₐₛₛ read and held by the password selection portion 206 is outputted to the communication portion 205.

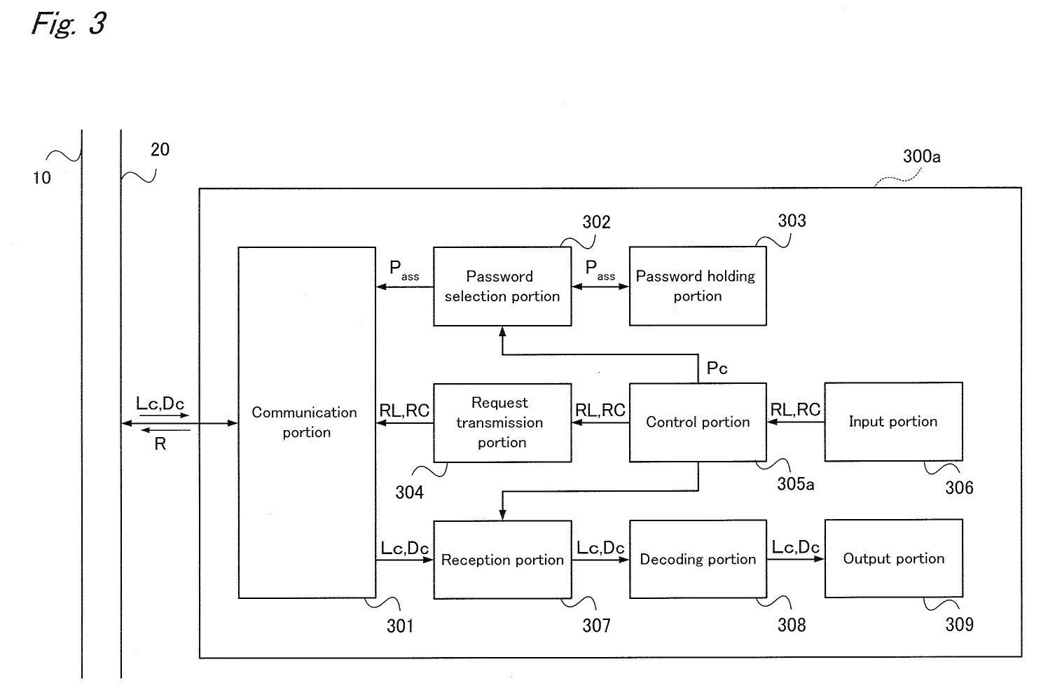

Next, the secondary contractual terminal device 300a will be described with reference to FIG. 3. The secondary contractual terminal device 300a includes a communication portion 301, a password selection portion 302, a password holding portion 303, a request transmission portion 304, a control portion 305a, an input portion 306, a reception portion 307, a decoding portion 308, and an output portion 309. The decryption portion 308 is a parser or suchlike for analyzing content list information, or a decoder or suchlike for decoding video. The output portion 309 is, for example, a monitor for displaying video, or a loudspeaker for outputting audio.

The password selection portion 302 and the password holding portion 303 hold their respective different passwords Pₐₛₛ. In accordance with a password change instruction signal Pc inputted from the control portion 305a, the password selection portion 302 reads and holds the password Pₐₛₛ held in the password holding portion 303, and in exchange transfers its own password Pₐₛₛ to the password holding portion 303. The password Pₐₛₛ read and held by the password selection portion 302 is outputted to the communication portion 301.

The secondary contractual terminal device 300a has the function of playing back/displaying or recording contents (content data Dc) received via the network (the communication link 20). The secondary contractual terminal device 300a is connected to the communication link 20 on the coaxial cable network via the communication portion 301 having such functions as signal modulation/demodulation and packet transmission/reception.

The operation of the secondary contractual terminal device 300a will be described below, regarding the case where the user uses the secondary contractual terminal device 300a for content viewing. Once a content viewing instruction from the user using a remote control or suchlike is inputted to the secondary contractual terminal device 300a via the input portion 306, a content viewing operation is started.

First, to recognize contents stored in a content sender terminal device (in the present example, the primary contractual terminal device 200a), a content list is acquired. Concretely, a content list request RL is transmitted to the content sender terminal device via the request transmission portion 304 and the communication portion 301. The secondary contractual terminal device 300a receives a content list Lc, which has been transmitted in response to the content list request RL, from the sender terminal device via the communication portion 301 and the reception portion 307. The received content list Lc is decoded by the decoding portion 308 before being inputted to the output portion 309.

Next, the user selects a content item desired to acquire (view) based on the content list Lc displayed on the output portion 309. A content request RC for the selected content item is transmitted via the request transmission portion 304. In response to the content request RC, the primary contractual terminal device 200a transmits the content data Dc requested by the user to the secondary contractual terminal device 300a.

The secondary contractual terminal device 300a receives the content data Dc transmitted from the primary contractual terminal device 200a, via the communication portion 301 and the reception portion 307. The received content data Dc is then decoded by the decoding portion 308 before being outputted to the output portion 309. The output portion 309 plays back/displays the content item based on the content data Dc. Note that in the case of recording the received content item, the output portion 309 is configured by a device including a storage medium, such as an HDD or a DVD.

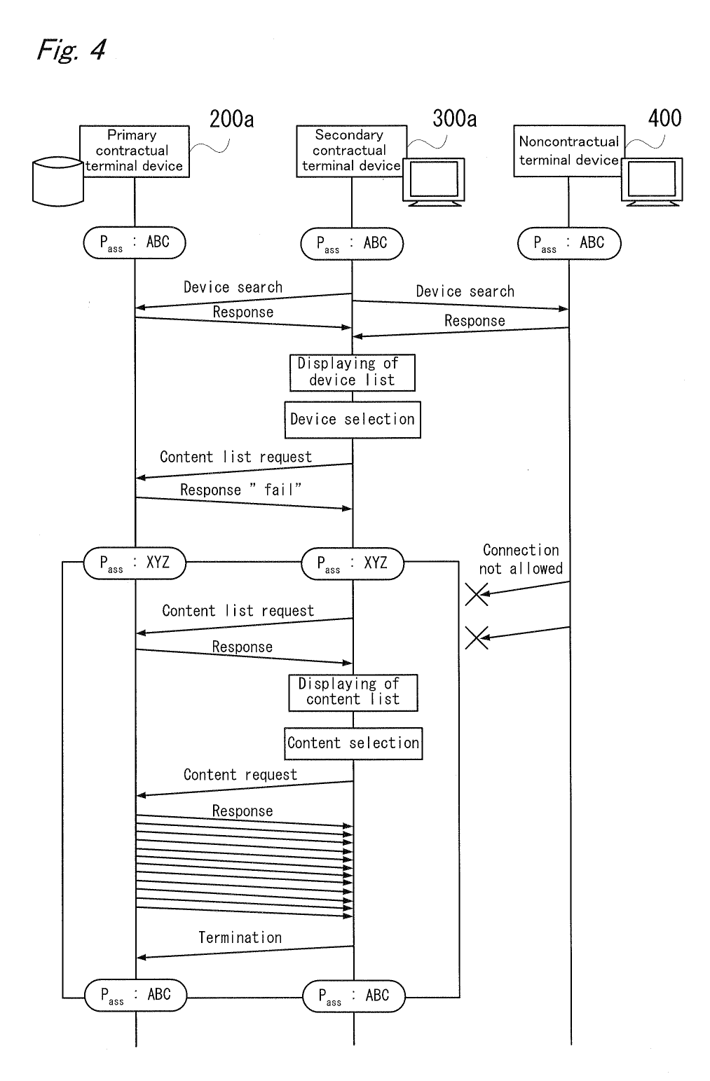

Next, the procedure for viewing contents stored in the primary contractual terminal device 200a from the secondary contractual terminal device 300a will be described with reference to FIG. 4. The primary contractual terminal device 200a, the secondary contractual terminal device 300a, and the noncontractual terminal device 400 are connected together via the communication link 20, with the relationship as shown in FIG. 1.

To perform packet communication via the coaxial cables, first, a common password for the primary contractual terminal device 200a, the secondary contractual terminal device 300a, and the noncontractual terminal device 400 is set as an initial setting. In the present example, “ABC” is set as the common password Pₐₛₛ. The password Pₐₛₛ is set through a manual input operation by the user when connecting each terminal device (the primary contractual terminal device 200a, the secondary contractual terminal device 300a, and the noncontractual terminal device 400) to the network.

Each terminal device (the primary contractual terminal device 200a, the secondary contractual terminal device 300a, and the noncontractual terminal device 400) uses the password Pₐₛₛ to establish a communication link with another terminal device. Concretely, one terminal device communicates the value for the password Pₐₛₛ to another device simultaneously with sending the other terminal device a request to establish a link therewith. Upon reception of the request to establish the link, the terminal device compares the value for the password Pₐₛₛ held therein with the communicated value for the password Pₐₛₛ. At this time, if the values for the password Pₐₛₛ match, the link is established, and if they don't match, no link is established. That is, any devices with the same password can establish a communication link between them, and any devices with different passwords from each other cannot establish a link between them.

In the case where there are terminal devices with inconsistent passwords Pₐₛₛ, even if they are connected by the same physical medium, it is not possible to establish a communication link between them, so that packet decoding is not possible. Specifically, the situation is equivalent to the case where the communication channel is encrypted by the password Pₐₛₛ being set.

In addition, the primary contractual terminal device 200a and the secondary contractual terminal device 300a are under the same contract, and therefore they hold the same password other than the password Pₐₛₛ being set as described above. The password Pₐₛₛ being commonly set for the primary contractual terminal device 200a, the secondary contractual terminal device 300a, and the noncontractual terminal device 400 is referred to hereinafter as a “common password P_{assC}”, so that it is distinguishable as necessary from the password held by only the primary contractual terminal device 200a and the secondary contractual terminal device 300a, which is referred to as a “secret password P_{assS}”. The secret password P_{assS} is taken as “XYZ”.

It is assumed that the secret password P_{assS} is not publicly open to the outside, and is only held by devices under the same contract as a common password. The secret password P_{assS} is held by both the password holding portion 207 of the primary contractual terminal device 200a and the password holding portion 303 of the secondary contractual terminal device 300a. However, the secret password P_{assS} is not held by the noncontractual terminal device 400.

In the case where “ABC” is set as the common password P_{assC} for the terminal devices as described above, if the user performs a network playback operation, the secondary contractual terminal device 300a first broadcasts a packet for device search over the network to search for any device connected over the same network. In the case where UPnP (universal plug and play) is used on TCP/IP as a communication protocol, an M-Search command is transmitted for device search.

Devices for which a response to the device search is returned are listed on the screen (the output portion 309) of the secondary contractual terminal device 300a. In the present example, the primary contractual terminal device 200a and the noncontractual terminal device 400 can be found, and therefore the user of the secondary contractual terminal device 300a is notified of the finding of these two devices.

Next, from among the devices listed on the output portion 309, the user selects one device from which to acquire (view) contents. In the present example, it is assumed that the user desires to view contents stored in the primary contractual terminal device 200a. In accordance with an instruction from the user, the secondary contractual terminal device 300a transmits a content list request RL to the primary contractual terminal device 200a.

The primary contractual terminal device 200a limits public exposure of content list information (the content list Lc), and therefore returns “fail” in response to the received content list request RL. Thereafter, the primary contractual terminal device 200a changes its password Pₐₛₛ. Concretely, the password selection portion 206 reads the secret password P_{assS} held in the password holding portion 207, and changes the password Pₐₛₛ for use in the communication portion 205 to the secret password P_{assS} being read. In the present example, the secret password P_{assS} is “XYZ”, and therefore instead of using “ABC”, “XYZ” is used as the password Pₐₛₛ. Note that the original password “ABC” is temporarily held in the password holding portion 207.

On the other hand, the secondary contractual terminal device 300a that has received the response “fail” to the content list request RL also changes its password Pₐₛₛ. The password selection portion 302 reads the secret password P_{assS} held in the password holding portion 303, and changes the password Pₐₛₛ for use in the communication portion 301 to the secret password P_{assS} being read. In the present example, the secret password is “XYZ” as described above, and therefore instead of using “ABC”, “XYZ” is used as the password Pₐₛₛ. The original password “ABC” is temporarily held in the password holding portion 303.

At this point, for both the primary contractual terminal device 200a and the secondary contractual terminal device 300a, the password Pₐₛₛ has been changed to “XYZ” for the secret password P_{assS}, and only the password for the noncontractual terminal device 400 remains “ABC” for the common password P_{assC}. That is, a secured communication channel is established, in which communication is possible only between the primary contractual terminal device 200a and the secondary contractual terminal device 300a.

After the secured communication channel is established, the secondary contractual terminal device 300a retransmits the content list request RL to the primary contractual terminal device 200a. For the content list request RL received via the communication channel that has been established with “ABC” for the password Pₐₛₛ, the primary contractual terminal device 200a cannot determine from which terminal device the request has been transmitted, and therefore returns the response “fail” as described above.

On the other hand, for the content request RC received via the communication channel that has been established with “XYZ” for the password Pₐₛₛ, the primary contractual terminal device 200a can determine that the request is a request for content acquisition that has been transmitted from a terminal device under the same contract, which has the secret password P_{assS}, and therefore the primary contractual terminal device 200a returns a normal response. Specifically, the content list Lc is transmitted to the secondary contractual terminal device 300a. Thus, the content list information is displayed on the screen (the output portion 309) of the secondary contractual terminal device 300a.

Note that a determination as to which password Pₐₛₛ is used for the communication channel through which the acquired content list Lc has been transmitted can be made based on the password Pₐₛₛ being temporarily held in the password holding portion 207. Specifically, if the password Pₐₛₛ being temporarily held in the password holding portion 207 is “ABC”, the password Pₐₛₛ for the communication channel currently being established is “XYZ”, whereas if the password Pₐₛₛ being temporarily held is “XYZ”, the password Pₐₛₛ for the communication channel is “ABC”.

Next, the user selects a content item desired to view from the list of contents (the content list Lc). In response to an instruction from the user, a content request RC is transmitted from the secondary contractual terminal device 300a to the primary contractual terminal device 200a. Upon reception of the content request RC, the primary contractual terminal device 200a transmits data for the requested content item (content data Dc) to the secondary contractual terminal device 300a.

The secondary contractual terminal device 300a decodes the received content data Dc, and plays back/displays the content item for the user. During the playback/display, the noncontractual terminal device 400 cannot obtain the details of communication. Specifically, only a device(s) under the same contract to which the secret password is known can participate in the network between the primary contractual terminal device 200a and the secondary contractual terminal device 300a, and therefore it is possible to limit information disclosure to the outside.

Upon completion of content viewing, the secondary contractual terminal device 300a changes its password Pₐₛₛ to the original “ABC”. The changing of the password Pₐₛₛ is executed by the password selection portion 302 reading the password Pₐₛₛ stored in the password holding portion 303. On the other hand, the primary contractual terminal device 200a that has completed content transmission also changes its password Pₐₛₛ to the original “ABC”. The changing of the password Pₐₛₛ is executed by the password selection portion 206 reading the password stored in the password holding portion 207.

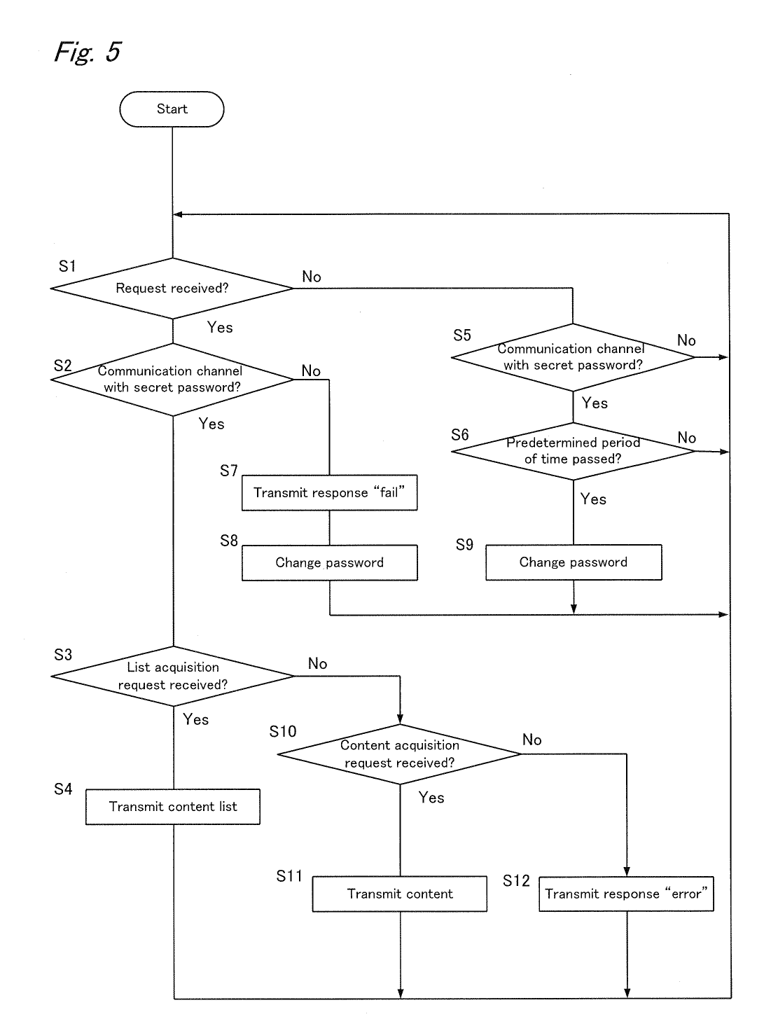

Next, the content transmission operation of the primary contractual terminal device 200a will be described in detail with reference to FIG. 5. The primary contractual terminal device 200a first transitions to a standby state. Then, in step S1, it waits for a request R to be transmitted from the receiver terminal device (in the present example, the secondary contractual terminal device 300a). Specifically, the determination “No” is made in step S1, and control advances to step S5.

In step S5, a determination is made, regarding whether the communication channel has been established with a secret password P_{assS}. Initially, no request R has yet been received, and therefore the determination “No” is made, so that control returns to step S1. Thereafter, upon reception of a request R, the determination “Yes” is made, so that control advances to the next step S2.

In step S2, a determination is made, regarding whether the request R has been transmitted over the communication channel that has been established with the secret password. The first request R is always transmitted over the communication channel that has been established with a common password P_{assC}, and therefore the determination “No” is made, so that control advances to step S7.

In step S7, the response “fail” is transmitted. Then, control advances to step S8.

In step S8, as a preparation for transmitting content information (a content list Lc and content data Dc) to the receiver terminal device (in the present example, the secondary contractual terminal device 300a), the password Pₐₛₛ is changed to the secret password P_{assS}. The reason for this is, as described above, that the communication channel that has been established with the secret password P_{assS} is used to transmit the content data Dc and the content list Lc. Then, control returns to step S1.

After the changing of the password Pₐₛₛ in step S8, and retransition to the standby state in step S1, if another request R is received, the request is made over the communication channel that has been established with the secret password P_{assS}, and therefore the determination “Yes” is made in step S2, so that control advances to step S3.

In step S3, a determination is made, regarding whether the request R is a content list request RL. When the determination “Yes” is made, control advances to step S4. In step S4, the content list Lc is transmitted, and thereafter control returns to step S1.

If the determination “No” is made in step S3, control advances to step S10. In step S10, a determination is made, regarding whether the request R is a content request RC. When the determination “Yes” is made, control advances to step S11. In step S11, the content data Dc is transmitted, and thereafter control returns to step S1.

If the determination “No” is made in step S10, control advances to step S12. In step S12, the response “error” is returned for the reason that the details of the request R are determined not to be analyzable, and thereafter control returns to step S1.

After the transmission of the content data Dc is completed, no request R is made by the receiver terminal device (the secondary contractual terminal device 300a) over the communication channel that has been established with the secret password P_{assS}. Therefore, the determination “No” is made in step S1, and control advances to step S5. Since the communication channel has been established with the secret password P_{assS}, the determination “Yes” is made in step S5, so that control advances to step S6.

In step S6, when a predetermined period of time is determined to passed, control advances to step S9. In step S9, the password Pₐₛₛ is changed from the secret password P_{assS} to the original common password P_{assC}. Then, control returns to step S1. This processing is intended for the procedure to repeatedly pass through the processing in steps S1, S5, and S6 after the transmission of the content data Dc has been completed, in order to keep waiting for another request R from the receiver terminal device, thereby avoiding the situation where no link with any terminal device to which the secret password P_{assS} is unknown can be established because the communication channel is left established with the secret password P_{assS}.

Therefore, in step S6, a period of time during which no communication is performed over the communication channel that has been established with the secret password P_{assS} is measured, and after the predetermined period of time passes, the password is forced to revert to the original common password P_{assC}.

On the other hand, the primary contractual terminal device 200a performs the following operation when the content list request RL is made by any terminal device (in the present example, the noncontractual terminal device 400) to which no contents are allowed to be exposed. First, when the request R is received in step S1, the request has been made over the communication channel established with the common password P_{assC}, and therefore the determination “No” is made in step S2. Then, in step S7, the response “No” is transmitted.

Next, in step S8, the password Pₐₛₛ is changed to the secret password P_{assS}. The primary contractual terminal device 200a retransitions to the state in step S1 to wait for another request R. At this time, the primary contractual terminal device 200a waits for the request R over the communication channel that has been established with the secret password P_{assS}, and therefore any terminal device without the secret password P_{assS} (in the present example, the noncontractual terminal device 400) can neither transmit the request R nor establish any link. Specifically, in this state, the terminal device without the secret password P_{assS} (the noncontractual terminal device 400) is not allowed to acquire any content-related information (a content list Lc and content data Dc).

Thereafter, when the predetermined period of time has passed, the determination “Yes” is made in step S6, and the password Pₐₛₛ is changed to the common password P_{assC} again in step S9. When the common password P_{assC} is set, other terminal devices (the secondary contractual terminal device 300a and the noncontractual terminal device 400) can find the primary contractual terminal device 200a, and the primary contractual terminal device 200a can access the other terminal devices (the secondary contractual terminal device 300a and the noncontractual terminal device 400).

Note that in the present example, the receiver terminal device (the secondary contractual terminal device 300a) acquires the content data Dc after the content list Lc, but the same behavior as described above is effected even in the case where the content list Lc is not acquired, and, for example, the content storage location is specified to directly acquire the content data Dc.

Specifically, when the first content request RC is received, the determinations “Yes” and “No” are made in steps S1 and S2, respectively, and therefore the response “fail” to the content request RC is transmitted in step S7. Then, in step S8, the password Pₐₛₛ is changed to the secret password P_{assS}. In this state, if no request R is made by the receiver terminal device, the receiver terminal device (in the present example, the noncontractual terminal device 400) has failed to establish a communication link.

Therefore, the receiver terminal device is determined to be the noncontractual terminal device 400 without the secret password P_{assS}, and therefore after the predetermined period of time has passed, the password Pₐₛₛ is changed to the common password P_{assC} again in step S9. On the other hand, if the request R is received during the standby state after the password Pₐₛₛ has been changed to the secret password P_{assS}, the receiver terminal device has succeeded in establishing a communication link. Therefore, the receiver terminal device is determined to be the secondary contractual terminal device 300a with the secret password P_{assS}, and therefore contents and content-related list information are publicly exposed. In this case, since the content data Dc is directly requested, the determination “Yes” is made in step S10, and the content data Dc is transmitted in step S11. As such, the primary contractual terminal device 200a can effect access limitation regardless of the acquisition procedure of the receiver terminal device.

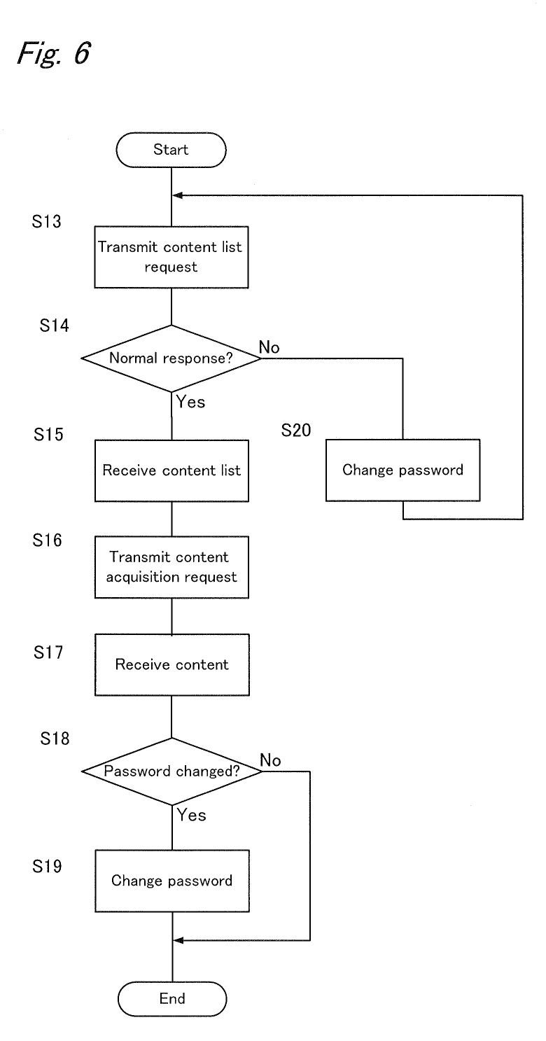

Next, the content acquisition procedure of the secondary contractual terminal device 300a will be described in detail with reference to FIG. 6. The secondary contractual terminal device 300a first transmits the content list request RL in step S13 to acquire content list information from a device found on the network.

In step S14, a determination is made, regarding whether a response made by the primary contractual terminal device 200a to the content list request RL transmitted in step S13 is normal. Note that when the sender terminal device (the primary contractual terminal device 200a) is a device, such as a PC, on which no access limitation is imposed, a normal response is returned. When the determination “Yes” is made, control advances to step S15.

In step S15, the content list information is acquired based on the content list Lc transmitted from the primary contractual terminal device 200a. Then, control advances to step S16.

In step S16, the content request RC is transmitted in response to the user's content selection based on the content list Lc. Then, control advances to step S17.

In step S17, the content data Dc that has been transmitted from the primary contractual terminal device 200a in response to the content request RC is received. Then, after the reception of the content data Dc is completed, control advances to step S18.

In step S18, a determination is made, regarding whether the password Pₐₛₛ has been changed. Note that at this point, the password Pₐₛₛ has not yet been changed, the determination “No” is made, so that a series of operations are terminated.

On the other hand, if the sender terminal device (the primary contractual terminal device 200a) is a terminal device on which the above-described access limitation is imposed, “fail” is returned in response to the content list request RL (“No” in step S14). When the secondary contractual terminal device 300a receives the response “fail”, it changes the password Pₐₛₛ for the communication channel to the secret password P_{assS} in order to acquire content information over a secured communication channel (step S20), and retransmits the content list request RL (step S13). The sender terminal device (the primary contractual terminal device 200a) returns a normal response to the request R that has been transmitted via the communication channel with the secret password P_{assS}, and therefore the determination “Yes” is made in step S14, so that the content list Lc can be received (step S15).

Thereafter, another content request RC is transmitted similarly (step S16), and content data Dc is received (step S17). After the reception of the content data Dc is completed, a determination is made, regarding whether the password Pₐₛₛ has been changed (step S18). At this point, since the password Pₐₛₛ has already been changed, the determination “Yes” is made in step S18, and the password Pₐₛₛ is changed to the original common password P_{assC} (step S19). Thus, a series of operations are terminated.

By configuring the primary contractual terminal device 200a and the secondary contractual terminal device 300a as described above, contents and information associated therewith are exchanged between the terminal devices with the common secret password P_{assS} over a secured communication channel. Specifically, access limitation can be imposed on the terminal device without the secret password P_{assS} (the noncontractual terminal device 400). In addition, while no data is being transferred between the two terminal devices, communication is performed using the common password P_{assC}, and therefore it is also possible to view contents stored in the noncontractual terminal device 400.

Note that in the present example, the number of devices to be connected to the communication link 20 is one for each of the primary contractual terminal device 200a, the secondary contractual terminal device 300a and the noncontractual terminal device 400, but it is not restrictive. In addition, the device distinction is merely an example, and is not limited by the contract type of the CATV. Specifically, the present invention is applicable to a specific group in which a plurality of terminal devices can freely expose their contents to each other but not to any terminal device outside the group, although they can access any contents stored in the terminal device outside the group. In this case, the terminal devices in the specific group hold a common secret password.

In addition, the number of groups on which to impose access limitation is not limited to one. For example, if there are three such groups, three different secret passwords P_{assS1}, P_{assS2}, and P_{assS3} are held for their respective groups, making it possible to effect access limitation per group.

Furthermore, one terminal device may belong to different groups. In such a case, the terminal device is required to hold secret passwords P_{assS1} to P_{assSm}, the number of which is equal to the number of groups to which the device belongs. In the case where one terminal device holds the secret passwords P_{assS1} to P_{assSm}, the password Pₐₛₛ is repeatedly changed until a link with another terminal device is established to enable information transmission/reception, thereby establishing a secured communication channel between the two terminal devices. Alternatively, a unique ID may be unambiguously assigned per device to identify the group to which the other terminal device belongs. In the case of using such IDs, by making in advance a list containing terminal device IDs, terminal device groups, and secret passwords P_{assS} corresponding to the groups, and identifying a secret password P_{assS} based on an acquired ID of another terminal device, it becomes possible to establish a secured communication channel between two terminal devices.

### Second Embodiment

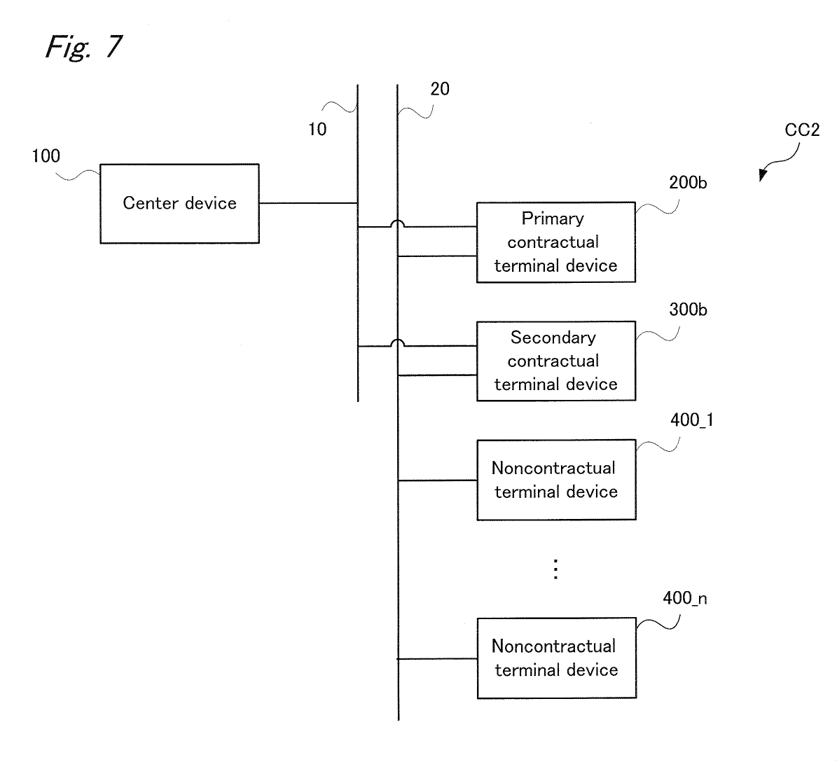

A broadcast reception system according to a second embodiment of the present invention will be described below with reference to FIGS. 7, 8, 9, and 10.

As shown in FIG. 7, a network system CC2 includes a primary contractual terminal device 200b and a secondary contractual terminal device 300b, which are provided in place of the primary contractual terminal device 200a and the secondary contractual terminal device 300a, respectively, of the network system CC1 shown in FIG. 1. In addition, the primary contractual terminal device 200b includes a control portion 209b, which is provided in place of the control portion 209a of the primary contractual terminal device 200a. Also, the secondary contractual terminal device 300b includes a control portion 305b, which is provided in place of the control portion 305a of the secondary contractual terminal device 300a. Moreover, n noncontractual terminal devices 400_1 to 400_{—}n (where n is an arbitrary natural number) are provided in place of one noncontractual terminal device 400.

Specifically, a center device 100, the primary contractual terminal device 200b, and the secondary contractual terminal device 300b are connected together via a broadcast link 10 to constitute a television broadcast system. In addition, the primary contractual terminal device 200b, the secondary contractual terminal device 300b, and the noncontractual terminal devices 400_1 to 400_{—}n are connected together via a communication link 20 to constitute a coaxial cable network system.

In the network system CC2 also, it is required that any contents saved in the primary contractual terminal device 200b can be viewed only on the secondary contractual terminal device 300b, but not on the noncontractual terminal devices 400_1 to 400_{—}n. Moreover, it is required that any contents saved in the noncontractual terminal devices 400_1 to 400_{—}n can conversely be viewed on the secondary contractual terminal device 300b and the primary contractual terminal device 200b. For simplification of explanation, the following description will be given on the assumption that n=2, i.e., the two noncontractual terminal devices 400_1 to 400_2 are connected to the coaxial cable network system. The following description focuses on characteristics specific to the present embodiment.

In the present embodiment also, the service provider desires any contents distributed from the center device 100 to be viewed only on viewing terminal devices under official contract. Specifically, it is required that any contents stored in the primary contractual terminal device 200b can be viewed only on the secondary contractual terminal device 300b, but not on the noncontractual terminal devices 400_1 and 400_2.

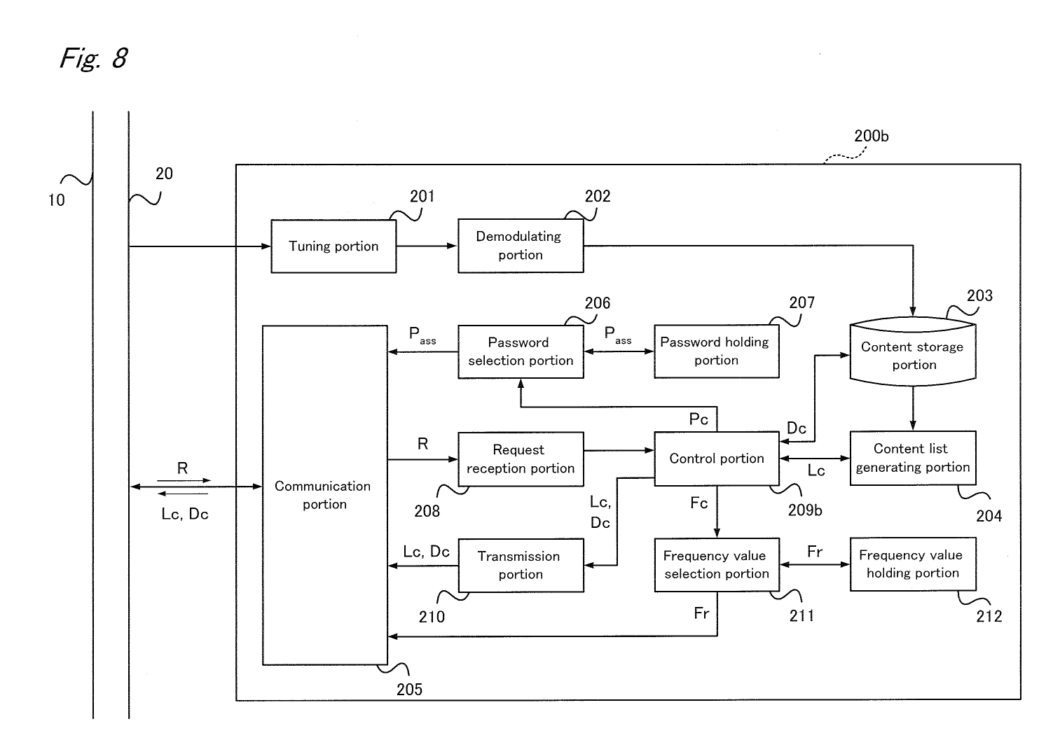

As shown in FIG. 8, the primary contractual terminal device 200b is configured by additionally providing a frequency value selection portion 211 and a frequency value holding portion 212 to the above-described primary contractual terminal device 200a. The frequency value holding portion 212 has prestored therein a plurality of frequency values Fr. The frequency value selection portion 211 selectively reads one of the frequency values Fr stored in the frequency value holding portion 212 onto the communication portion 205 in accordance with a frequency value change instruction signal Fc inputted from the control portion 209b.

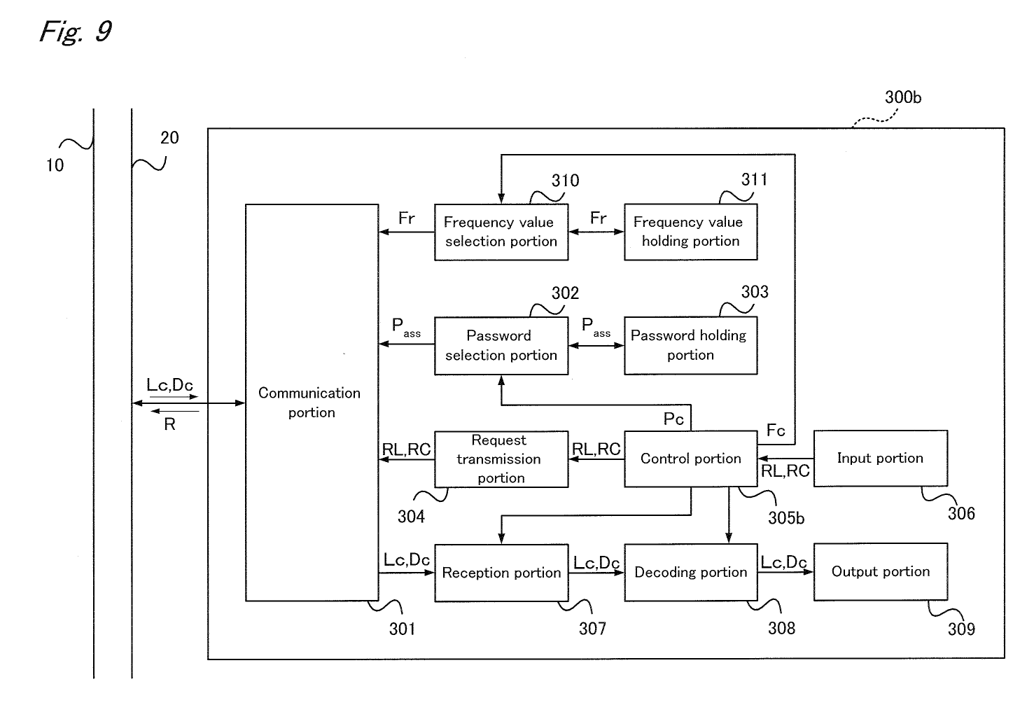

As shown in FIG. 9, the secondary contractual terminal device 300b is configured by additionally providing a frequency value selection portion 310 and a frequency value holding portion 311 to the above-described secondary contractual terminal device 300a. The frequency value holding portion 311 has prestored therein a plurality of frequency values Fr. The frequency value selection portion 310 selectively reads one of the frequency values Fr stored in the frequency value holding portion 311 onto the communication portion 301 in accordance with a frequency value change instruction signal Fc inputted from the control portion 305b.

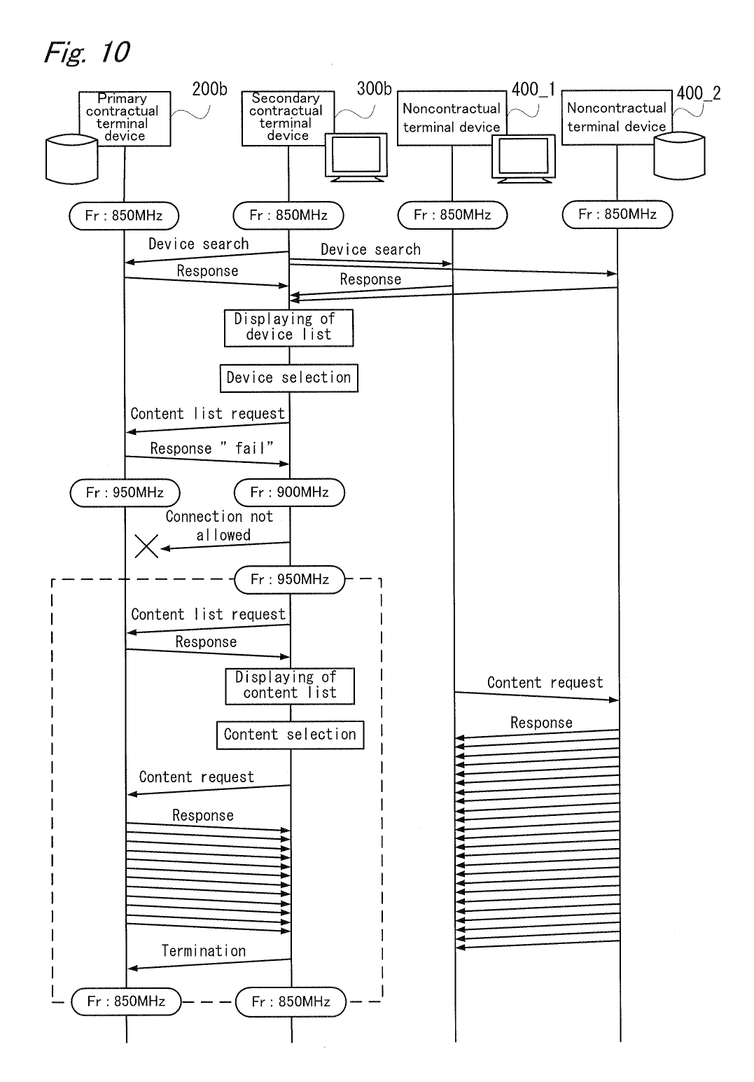

Next, the procedure for viewing contents stored in the primary contractual terminal device 200b from the secondary contractual terminal device 300b will be described with reference to FIG. 10. The primary contractual terminal device 200b, the secondary contractual terminal device 300b, and the noncontractual terminal devices 400_1 and 400_2 are connected together via the communication link 20, with the relationship as shown in FIG. 7.

To perform packet communication via the coaxial cables, the frequency value Fr and the common password Pₐₛₛ are first set as initial settings for use in transmission by each terminal device. In the present embodiment, there are three available frequency values: 850 MHz; 900 MHz; and 950 MHz. The frequency values Fr of 850 MHz, 900 MHz, and 950 MHz are hereinafter distinguished as frequency values Fr1, Fr2, and Fr3, respectively.

The following description will be given by taking as an example the case of using the frequency value Fr1 (850 MHz). The available frequency values Fr (Fr1: 850 MHz, Fr2: 900 MHz, and Fr3: 950 MHz) are stored in both the frequency value holding portion 212 of the primary contractual terminal device 200b, and the frequency value holding portion 311 of the secondary contractual terminal device 300b. In the case where the primary contractual terminal device 200b and the secondary contractual terminal device 300b use different frequency values, they cannot communicate with each other because any transmission signal cannot be correctly demodulated even if they are connected via the same physical medium.

In the present example also, the common password P_{assC} is taken as “ABC”. In the network system CC2, when the settings as described above are made, and the user performs an operation to perform playback via the network, the secondary contractual terminal device 300b first broadcasts a packet for device search over the network, so that any devices connected on the same network are found. Devices for which a response to the device search is returned are listed on the screen of the secondary contractual terminal device 300b. In the present example, the primary contractual terminal device 200b, and the noncontractual terminal devices 400_1 and 400_2 are found, and the user of the secondary contractual terminal device 300b is notified of the finding of these three devices.

Next, the user selects a device from which to acquire desired contents from among the listed devices. In the present example, the user desires to view contents in the primary contractual terminal device 200b. The secondary contractual terminal device 300b transmits the content list request RL to the primary contractual terminal device 200b in accordance with an instruction from the user.

The primary contractual terminal device 200b limits public exposure of content list information, and therefore initially returns “fail” in response to the received content list request RL. Thereafter, the primary contractual terminal device 200b changes its frequency value Fr. The frequency value selection portion 211 arbitrarily selects one value from among the frequency values stored in the frequency value holding portion 212, thereby changing the frequency value to be used for transmission by the communication portion 205. In the present example, the frequency value is changed from 850 MHz to 950 MHz. Note that the original frequency value 850 MHz is temporarily held by the frequency value holding portion 212.

On the other hand, the secondary contractual terminal device 300b that has received the response “fail” to the content list request RL also changes its frequency value Fr. Concretely, the frequency value selection portion 310 sequentially reads one of the frequency values Fr stored in the frequency value holding portion 311 to change the frequency value Fr to be used for transmission by the communication portion 301. Initially after the change from the frequency value Fr1 (850 MHz) to the frequency value Fr2 (900 MHz), the transmission of the content list request RL is attempted again. However, the primary contractual terminal device 200b waits for another request R to be received with the frequency value Fr3 (950 MHz), and therefore communication cannot be performed due to the difference in frequency value.

The secondary contractual terminal device 300b detects that the request R is unsuccessful, for example, because no response has been made within a predetermined period of time, and therefore it changes the frequency value Fr again. In the present example, the frequency value Fr is changed from the frequency value Fr2 (900 MHz) to the frequency value Fr3 (950 MHz). At this point, if the secondary contractual terminal device 300b retransmits the content list request RL, the two terminal devices (the primary contractual terminal device 200b and the secondary contractual terminal device 300b) can communicate with each other because they use the same frequency value (the frequency value Fr3). Specifically, the primary contractual terminal device 200b responds to the content list request RL, and transmits a content list Lc. As a result, content list information is displayed on the screen of the secondary contractual terminal device 300b. Note that the original frequency value 850 MHz (the frequency value Fr1) is temporarily held in the frequency value holding portion 311.

Next, the user selects a content item desired to be viewed from the content list. In accordance with the user's selection operation, the secondary contractual terminal device 300b transmits a content request RC to the primary contractual terminal device 200b. Upon reception of the content request RC, the primary contractual terminal device 200b transmits content data Dc to the secondary contractual terminal device 300b. The secondary contractual terminal device 300b decodes the received content data Dc, thereby making it possible for the user to view the content item.

The secondary contractual terminal device 300b and the noncontractual terminal device 400 use different frequency values from each other for transmission. Therefore, even if the noncontractual terminal device 400_1 carries out content transmission to/content reception from the noncontractual terminal device 400_2 while the secondary contractual terminal device 300b is playing back/displaying the content data Dc acquired from the primary contractual terminal device 200b, there are no problems such as transmission from one device affecting transmission from another, or packet transmission being delayed. Specifically, by using the different frequency values for transmission, it becomes possible to ensure a stable communication channel.

Upon completion of content viewing, the secondary contractual terminal device 300b changes its frequency value Fr to the original frequency value Fr1 (850 MHz). The frequency value Fr is changed by the frequency value selection portion 310 reading the original frequency value (frequency Fr1: 850 MHz), which is temporarily being held in the frequency value holding portion 310.

On the other hand, the primary contractual terminal device 200b that has completed content transmission also changes its frequency value Fr to the frequency value Fr1 (850 MHz). The frequency value Fr is changed by the frequency value selection portion 211 reading the frequency value (the frequency Fr1: 850 MHz) temporarily held in the frequency value holding portion 212.

As described above, in the network system CC2 including the primary contractual terminal device 200b and the secondary contractual terminal device 300b, a common frequency value is used for transmission between the devices in the same group, making it possible to impose access limitation on any device outside the group. In addition, the frequency value that is used for transmission varies between the devices inside and outside the group, and therefore communication inside the group does not affect communication outside the group or vice versa, making it possible to ensure stable transmission quality. Moreover, while no data is being transferred between two terminal devices (in the present example, the primary contractual terminal device 200b and the secondary contractual terminal device 300b), communication is performed with the original frequency value (in the present example, the frequency value Fr1: 850 MHz), and therefore any contents stored in the noncontractual terminal devices 400_1 to 400_{—}n can be viewed.

Note that in the present embodiment, as for each of the primary contractual terminal device 200b and the secondary contractual terminal device 300b, the number of devices to be connected to the communication link 20 is one, whereas the number of noncontractual terminal devices 400_1 to 400_{—}n to be connected is two. However, the number of devices to be connected is not limited. In addition, the device distinction is merely an example, and the distinction by the contract type of CATV is not restrictive.

Specifically, any contents are freely exposed to a plurality of terminal devices in one group (in the present example, the primary contractual terminal device 200b and the secondary contractual terminal device 300b), but not exposed to any terminal devices outside the group (in the present example, the noncontractual terminal devices 400_1 to 400_{—}n). Moreover, the present embodiment is applicable to a specific group (in the present example, the primary contractual terminal device 200b and the secondary contractual terminal device 300b) that can access any contents stored in terminal devices (in the present example, the noncontractual terminal device 400_1 to 400_{—}n) that do not belong to that same specific group. In this case, the terminal devices in the specific group (in the present example, the primary contractual terminal device 200b and the secondary contractual terminal device 300b) have the function of switching between frequency values.

In addition, the number of groups on which to impose access limitation is not limited to one. For example, if there are three such groups, three different frequency values are used for their respective groups to impose access limitation per group. In addition, one terminal device may belong to a plurality of different groups.

Furthermore, although it has been described that each terminal device holds available frequency value Fr, the frequency value Fr to be used may be determined at random, for example. In addition, in the case where the status of communication after a change of the frequency value is unsatisfactory, so that sufficient transmission performance is not ensured, the frequency value may be changed again.

Furthermore, although a scheme is employed, such that the primary contractual terminal device 200b, and the secondary contractual terminal device 300b individually select a value to which the frequency value Fr is changed, the frequency value Fr that has been selected by one device may be notified to the other. Note that if the value to which the frequency value Fr is changed leaks, communication channel confidentiality is not ensured, and therefore the frequency value Fr is preferably transmitted after being encrypted. It is understood that instead of changing only the frequency value Fr, by changing the password Pₐₛₛ for the communication channel at the same time, communication confidentiality is enhanced.

The communication control device of the present invention is particularly useful in CATV systems or suchlike in which packet communication is performed using communication lines such as coaxial cables.

Although the present invention has been described in terms of the presently preferred embodiments, it is to be understood that such disclosure is not to be interpreted as limiting. Various alterations and modifications will no doubt become apparent to those skilled in the art to which the present invention pertains, after having read the above disclosure. Accordingly, it is intended that the appended claims be interpreted as covering all alterations and modifications as fall within the true spirit and scope of the invention.

1. A communication control device for use in a network constituted by a first terminal device holding content, and a plurality of second terminal devices connected to the first terminal device, the control device comprising:
a transmission unit for transmitting either the content or information associated therewith, or both, to the second terminal devices;
a password selection unit for selecting and reading either a common password required for connecting to the network or a secret password required for establishing a communication channel with a specific one of the second terminal devices; and
a transmission control unit for causing the transmission unit to transmit either the content or the associated information, or both, via the network established by using the password selected by the password selection unit.

2. The communication control device according to claim 1, further comprising a password holding unit for holding the common password and the secret password.

3. The communication control device according to claim 1, wherein upon detection that the transmission unit has transmitted neither the content nor the associated information for a predetermined period of time, the transmission control unit causes the password selection unit to read a different password.

4. The communication control device according to claim 1, wherein the transmission control unit causes the password selection unit to select the secret password.

5. The communication control device according to claim 4, wherein upon detection that the transmission unit has transmitted neither the content nor the associated information for a predetermined period of time, the transmission control unit causes the password selection unit to read a different password.

6. A communication control device for use in a network constituted by a first terminal device holding content, and a plurality of second terminal devices connected to the first terminal device, the control device comprising:
a reception unit for receiving either the content or information associated therewith, or both, from the first terminal device;
a password selection unit for selecting and reading either a common password required for connecting to the network or a secret password required for establishing a communication channel with the first terminal device; and
a reception control unit for causing the reception unit to receive either the content or the associated information, or both, via the network established by using the password selected by the password selection unit.

7. The communication control device according to claim 6, further comprising a password holding unit for holding the common password and the secret password.

8. The communication control device according to claim 6, wherein upon detection that the reception unit has received neither the content nor the associated information for a predetermined period of time, the reception control unit causes the password selection unit to read a different password.

9. A communication control device for use in a network constituted by a first terminal device holding content, and a plurality of second terminal devices connected to the first terminal device, the control device comprising:
a transmission unit for transmitting either the content or information associated therewith, or both, to a specific one of the second terminal devices;
a frequency value holding unit for holding a plurality of frequency values for use in signal transmission;
a frequency value selection unit for selecting and reading one of the frequency values held in the frequency value holding unit; and
a transmission control unit for causing the transmission unit to transmit either the content or the associated information, or both, via the network established by using the frequency value selected by the frequency value selection unit.

10. The communication control device according to claim 9, wherein upon detection that the transmission unit has transmitted neither the content nor the associated information for a predetermined period of time, the transmission control unit causes the frequency value selection unit to read a different frequency value.

11. A communication control device for use in a network constituted by a first terminal device holding content, and a plurality of second terminal devices connected to the first terminal device, the control device comprising:
a reception unit for receiving either the content or information associated therewith, or both, from the first terminal device;
a frequency value holding unit for holding a plurality of frequency values for use in signal transmission;
a frequency value selection unit for selecting and reading one of the frequency values held in the frequency value holding unit; and
a reception control unit for causing the reception unit to receive either the content or the associated information, or both, via the network established by using the frequency value selected by the frequency value selection unit.

12. The communication control device according to claim 11, wherein upon detection that the reception unit has received neither the content nor the associated information for a predetermined period of time, the reception control unit causes the frequency value selection unit to read a different frequency value.
